(19) United States
(12) Patent Application Publication
(10) Pub. No.: US 2008/0196940 A1
(43) Pub. Date: Aug. 21, 2008

(54) Textile material comprising a circuit module and an antenna

(76) Inventors: Anatoli Stobbe, Barsinghausen (DE); Norman Maass, Hannover (DE)

Correspondence Address: COLLARD & ROE, P.C., 1077 NORTHERN BOULEVARD, ROSLYN, NY, 11576, US

(21) Appl. No.: 12/070,190

(22) Filed: Feb. 14, 2008

(30) Foreign Application Priority Data
Feb. 16, 2007 (DE) 10 2007 008 316.7

(51) Int. Cl. H01Q 1/27; H02G 1/00

(52) U.S. Cl. 174/70 R; 343/718

(57) ABSTRACT

The invention relates to a textile material comprising a circuit module (20, 24) and an antenna (12), wherein the antenna (12) is configured as an E field emitter for a working frequency in the UHF or microwave range and consists entirely of components of the textile material itself in the form of electrically conductive thread structures which are mechanically processed within the industrial weaving production process usual for textiles to form antenna structures. According to the invention, in the narrow band weaving production process the antenna structures are formed by asymmetric meander structures comprising a continuous electrically conductive weft thread (14) which runs in sections parallel and/or obliquely to the warp threads and is guided forwards to the effective edge (18) and immediately backwards between the sections (16) transverse to the warp threads.

The invention relates to a textile material comprising a circuit module and an antenna according to the preamble of claim 1.

Transponders comprising a circuit module and an antenna are being increasing used for the identification of goods during production, logistics, sale and repair, these being superior to conventional barcodes in terms of readability and data volume as well as tamper resistance. The use of transponders in textile goods is also being strived for, but because of their flexible character and the need for cleaning in hot and/or chemically aggressive media, higher requirements are imposed. Thus, the transponder must not adversely effect the use of the textile goods as intended, it must be resistant to thermal and chemical influences and despite this, operate physically reliably.

A textile material comprising a circuit module and an antenna is already known from WO 2005/071605 A2. The antenna disclosed therein is configured as an E field emitter for a working frequency in the UHF or microwave range and consists entirely of electrically conductive components of the textile material itself in the form of electrically conductive thread structures which are processed mechanically within the industrial weaving production process usual for textiles to form antenna structures.

When the E field emitter is accommodated in small-area textile materials, for example, textile labels, a mechanical shortening of the E field emitter is usually required. At a working frequency in the UHF range and at a working frequency in the microwave range, at least in the UHF range an electrical lengthening of the mechanically shortened E field emitter is required to match its resonance frequency to the working frequency.

WO 2005/071605 A2 teaches quite generally that if a mechanically shortened E field emitter must be brought into resonance with the working frequency by means of inductances, their geometry must be configured to be compatible with the industrial production process usual for textiles.

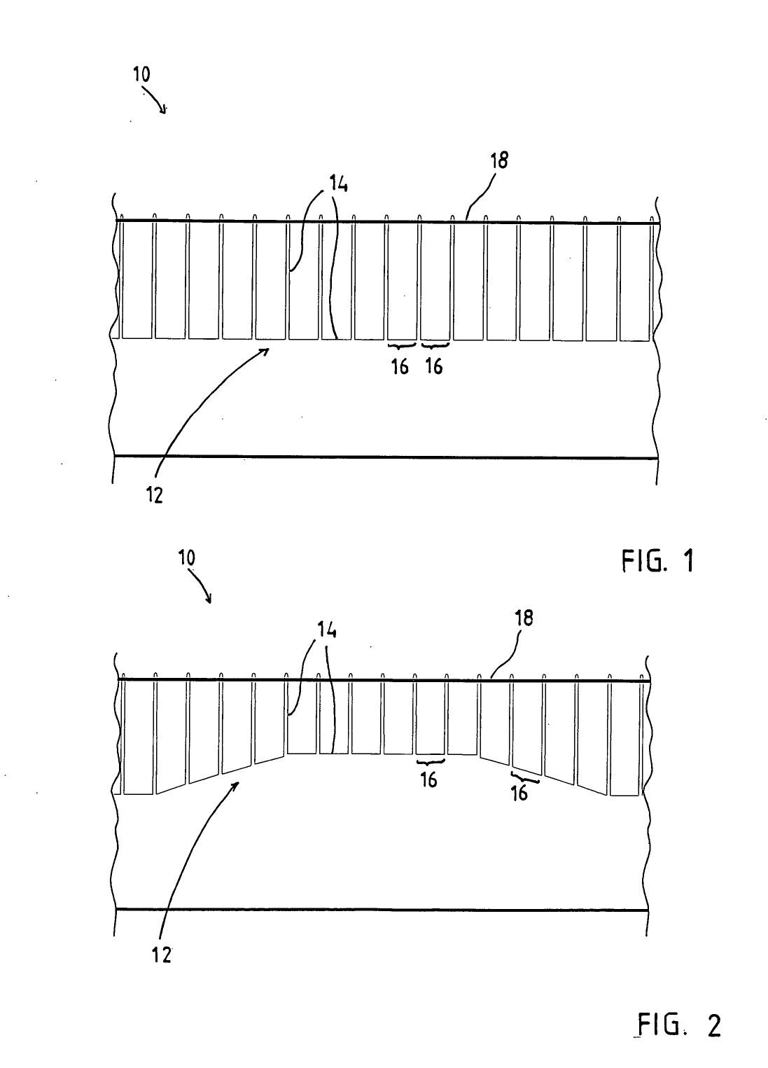

Thus, it is known from WO 2005/071605 A2 that during the weaving production process, antenna structures can be formed by meander structures from a continuous electrically conductive weft thread which is guided between each weft over a section corresponding to a plurality of weft thread thicknesses at the respective weaving edge parallel to the warp threads. Such a dipole antenna with a circuit module connected to the centrally separated dipole is shown in FIG. 1a of WO 2005/071605 A2.

It is also known from that in the broad-band weaving production process, that is during weaving using a broad-band machine, the antenna structures comprise a plurality of adjacently located, electrically conductive weft threads to form two electrically conductive surfaces. The circuit module is disposed between said surfaces and is galvanically connected thereto by means of electrically conductive warp threads which run transversely over all the weft threads of the electrically conductive surfaces. Such an antenna with a centrally connected circuit module is shown in FIG. 1d of WO 2005/071605 A2.

It has now emerged that textile material having said antenna structures can only be produced using looms which either need to be expensively converted or newly acquired fitted with corresponding additional modules.

It is therefore the object of the invention to provide an antenna structure in a textile material with electrically conductive thread structures, which can be produced with conventional looms jointly with the textile material.

This object is achieved with a textile material according to the preamble of claim 1 by the characterising features of claim 1.

Further developments and advantageous embodiments of the invention are obtained from the back-related dependent claims.

In the solution according to the invention, the antenna structures are formed by asymmetric meander structures in the narrow-band weaving production process. These comprise a continuous electrically conductive weft thread which runs in sections parallel and/or obliquely to the warp threads and is guided forwards to the effective edge and immediately backwards between the sections transverse to the warp threads.

Such an antenna structure can be formed in a simple manner at high production speed on a conventional narrow-band loom together with the textile material. Advantageously no expensive conversion measures are required for this.

The textile material is produced by narrow-band weaving by means of a needle loom in a known manner. To form the antenna structure according to the invention, the continuous electrically conductive weft thread according to the invention is inserted initially as a thread system at a predefined position into a predefined weaving shed as far as the effective edge, which can also be called a crochet edge, fixed there and immediately returned to the starting point of the weft insertion. The predefined position can be located anywhere in the textile material at a distance from the effective edge. The position can be located, for example, close to the weaving edge opposite to the effective edge, centrally or somewhere between the effective edge and said weaving edge. The position is specified by opening a corresponding weaving shed. After the continuous electrically conductive weft thread has been returned directly to the starting point of the weft insertion, no further insertion of the continuous electrically conductive weft thread is made over a predefined section. The textile material is further woven in a known manner and the continuous electrically conductive weft thread is entrained outside the textile material. At a next predefined position, the entrained continuous electrically conductive weft thread is again inserted in a predefined weaving shed as far as the effective edge, fixed there and returned immediately to the starting point of the weft insertion.

If the starting point of this weft insertion is located at the same height as the starting point of the previous insertion of the continuous electrically conductive weft thread, the section runs between these two starting points parallel to the warp threads. Otherwise, the section would run obliquely to the warp threads. The section is formed by the continuous electrically conductive weft thread entrained outside the textile material.

After the continuous electrically conductive weft thread has been returned directly to the second starting point of the weft insertion, again no further insertion of the electrically conductive weft thread takes place over a predefined section. The textile material is further woven in a known manner and the continuous electrically conductive weft thread is entrained outside the textile material. At a next predefined position, the entrained continuous electrically conductive weft thread is again inserted in a predefined weaving shed as far as the effective edge, fixed there and returned immediately to the starting point of the weft insertion. The process continues in this manner.

Since the position of insertion of the continuous electrically conductive weft thread can be predefined, within the scope of the invention, various antenna structures can be created by asymmetric meander structures which can be optimally matched to the present conditions, for example, the size of the textile material. Known narrow-band looms advantageously do not need to be expensively converted for this purpose.

A further development of the invention provides that the electrically conductive weft thread is insulated.

It has been shown that the E field emitter can be further mechanically shortened by the insulation of the electrically conductive weft thread. This is particularly advantageous with small-area textile materials which provide little space for the E field emitter, In addition, this has the result that a possible short circuit between the electrically conductive weft thread guided towards the effective edge and immediately back again is avoided. Such a short circuit would have the result that the corresponding branch of the E field emitter which is formed by the electrically conductive weft thread guided towards the effective edge and immediately back again would fail completely.

According to an advantageous embodiment of the invention, it is provided that the sections are configured to be the same or different length.

As has already been stated, the position of insertion of the continuous electrically conductive weft thread can be predefined. In precisely the same way, the section, i.e. the distance between two insertions of the continuous electrically conductive weft thread can advantageously also be predefined. Within the scope of the invention, therefore further antenna structures can be created by asymmetric meander structures which can be adapted to the present conditions such as space requirement, antenna gain or bandwidth. Known narrow-band looms advantageously do not need to be expensively converted for this purpose.

It is further provided that the textile material is a folded-end textile label, wherein the antenna structure runs over the entire length of the textile label so that the antenna structure is doubled in the end fold.

During narrow-band weaving, numerous interconnected textile labels are usually produced without interruption. On one side the textile labels are delimited by the effective edge, on the other side by the weaving edge.

As has already been stated, the antenna structure is formed by a continuous electrically conductive weft thread which during narrow band weaving, runs without interruption from one textile label to the next textile label.

After the narrow band weaving the textile labels are individually cut, i.e. separated from one another. The textile labels are usually cut hot to seal the cut edges with fixed fringes. The antenna structure thus runs over the entire length of the textile label according to the invention. Since the cut edges are relatively sharp-edged, the textile labels are end-folded, i.e., folded to the left and to the right.

It has now proved to be advantageous that the antenna structure is doubled in the end fold. This has the result that the antenna has a larger bandwidth. The continuous electrically conductive weft thread advantageously therefore need not have an exact length. The further textile processing can advantageously be carried out on standard cutting and folding machines.

A further development of the invention provides that at least one insulated, electrically conductive warp thread is provided which crosses the electrically conductive weft thread and/or that at least one insulated or non-insulated electrically conductive warp thread is provided which is disposed adjacent to the antenna structure in a non-contact manner.

It has been shown that one or more such warp threads allow a mechanical shortening of the E field emitter. This is particularly advantageous with small-area textile materials which provide little space for the E field emitter.

It is particularly appropriate if in the warp shed provided for the electrically conductive weft thread guided forwards to the effective edge and immediately backwards, at least one further textile weft thread together with the electrically conductive weft thread, is guided forwards to the effective edge and immediately backwards.

By inserting at least one further electrically non-conductive textile weft thread which is guided forwards to the effective edge and immediately backwards in the same weaving shed as the electrically conductive weft thread, an additional distance is achieved between the electrically conductive weft thread which is guided forwards and back again. Since the electrically conductive weft thread guided towards the effective edge is separated from the electrically conductive weft thread which is guided back immediately, by the textile weft thread or threads, the E field emitter can overall advantageously be mechanically shortened.

The objects specified initially is achieved by a textile material according to the preamble of claim 1 and by the characterising features of claim 7.

Further developments and advantageous embodiments of the invention are obtained from the back-related dependent claims.

The solution according to the invention provides that during the broad-band weaving production process, the antenna structures comprise a plurality of spaced-apart electrically conductive stubs. These stubs are each formed by at least one, preferably by a plurality, of electrically conductive weft threads, wherein the weft threads forming the stubs are interwoven with at least one, preferably with a plurality, of electrically conductive warp threads to produce conductive connections.

Such antenna structures can be simply produced at extremely high production speed on a convention broad loom together with the textile material. Advantageously no expensive conversion measures are required for this. A mechanically shortened E field emitter is produced in a simple manner by the spaced-apart stubs whose electrically conductive weft threads are conductingly connected by means of one or more electrically conductive warp threads.

The number of stubs, the number of weft threads forming each stub, the distance of the stubs from one another and the position and number of electrically conductive warp threads can be predefined according to the desired antenna structure.

The textile material is produced in a known manner by broad band weaving using a broad loom. In order to form the antenna structures according to the invention, at least one, preferably a plurality of adjacently located electrically conductive warp threads are inserted at predefined spaced-apart positions. The electrically conductive weft thread or threads inserted at these spaced-apart then form a so-called stub at each position. In order to form the antenna structures according to the invention, at a predefined position the weft thread or threads forming the stubs are interwoven with at least one, preferably with a plurality of adjacently located electrically conductive warp threads to produce conductive connections.

It is expressly noted that the antenna structures according to the invention do not vary if the spaced-apart stubs are formed not by one or more electrically conductive weft threads but by one or more electrically conductive warp threads and if, accordingly the warp thread or threads forming the stubs are interwoven with at least one, preferably with a plurality of adjacently located electrically conductive weft threads to produce conductive connections.

This is merely a question of viewpoint. Thus, exchanging the meaning of weft and warp threads does not lead to a different antenna structure. Therefore, the invention here and in the following should also be understood in this manner.

During broad band weaving, numerous textile labels are usually produced in a production process and these can be joined to neighbouring textile labels on all sides. After the broad band weaving these textile labels are initially cut to form narrow strips and subsequently separated and folded. Hot or ultrasound cutting ensure fixed-fringe cutting edges.

The arrangement of the electrically conductive weft and warp threads during broad-band weaving is such that each textile label has the already specified antenna structure according to the invention after cutting.

A further development of the invention provides that the electrically conductive weft threads are interwoven with the electrically conductive warp threads in a linen weave.

Such weaving substantially improves the contact between the electrically conductive weft and warp threads.

Appropriately, additionally at least one electrically conductive insulated warp thread is provided which crosses over the stubs.

It has been shown that on or more such warp threads permit a mechanical shortening of the E field emitter. This is particularly advantageous with small-area textile materials which provide little space for the E field emitters.

The electrically conductive thread or threads are preferably selected from the group comprising metal-coated plastic thread, a plastic thread wound with a metal wire or metal strands, a plastic thread with an integrated metal wire or an integrated metal strand and a graphite thread.

The choice is made depending on which type of electrically conductive threads are being processed with the respective narrow-band weaving or broad-band weaving production process, which type of electrically conductive threads have sufficient electrical conducting properties, which type of contact is made with the circuit module and whether and which chemical influences are present.

The electrically conductive insulated thread or threads are preferably selected from the group comprising a plastic thread with an integrated insulated metal wire, a plastic thread with an integrated insulated metal strand, an insulated metal wire and an insulated metal strand.

The circuit module can be coupled with the antenna structure by contact.

Antenna connections of the circuit module can be connected to the emitter by crimped connections, welded connections, soldered connections or adhesive connections using conductive adhesive.

In the production process, the textile material is initially fabricated without the circuit module. The circuit module is then connected to the emitter. Crimped connections have the advantage that the make electrical contact between the antenna connections and the emitter connections jointly with attaching the circuit module. The connection is made by mechanical clamping and is therefore also possible between conductive materials which cannot be connected electrically to one another by welding or soldering.

The circuit module can at the same time be fixed mechanically on the textile material if a plurality of threads can be enclosed which then jointly provide the necessary tensile strength. These can be electrically conductive and/or non-conductive threads.

Welded connections and soldered connections can be made between conductive materials made of metals. Finally, adhesive connections using conductive adhesives are also possible for materials which are neither suitable for crimped connections, welded connections and soldered connections.

The circuit module itself and its antenna connections are preferably enclosed by a potting compound and the potting compound is at the same time connected to the region of the textile material adjacent to the circuit module. The circuit module is thus fixed by the potting compound on the textile material since the potting compound penetrates deeply into the textile material due to the capillary effect. Separation is only possible through destruction so that tampering can be identified. Furthermore, the potting compound also protects the circuit module from mechanical and chemical influences. The additional bonding of the antenna connections provides protection for the contacts and at the same time provides stress relief of the emitter ends, thus reducing the risk of breakage at the antenna ends of the circuit module. A silicone compound has proved to be particularly suitable as a potting compound, both providing protection and fixing the circuit module on the textile material.

It is particularly preferable if the circuit module is coupled into the antenna in a non-contact manner.

Non-contact coupling of the circuit module is achieved by a coupling element which is coupled inductively and/or capacitively into the antenna. For this purpose, an electronic chip module is arranged together with the coupling element on the non-contact circuit module. The antenna itself, as has been described previously, is designed as an E field emitter and requires no galvanic connection to the chip module and coupling element.

The combination of the correspondingly matched coupling element and the antenna additionally results in an increase in the bandwidth of the entire system whereby operation is possible at different but neighbouring frequencies as a consequence of different national conditions without constructive changes and modifications.

The coupling element is preferably located at a site on the electrical antenna where a minimum standing wave ratio occurs.

The embodiment of the electrical antenna according to the invention as a dipole allows resonant matching to the working frequency and an antenna gain compared with isotropic emitters. As a result of the coupling element being located at a position on the electrical antenna where a minimum standing wave ratio occurs, optimal matching and range are achieved.

The non-contact circuit module can be fastened to the textile material by a reversibly detachable or irreversibly non-detachable fastening means.

In the case of reversibly detachable non-contact circuit modules, the non-contact circuit module can be removed, for example, after a production, transport or sales process if the information is no longer needed subsequently or is not to be used by unauthorised persons.

In the case of irreversibly non-detachably connected non-contact circuit modules, the information should remain permanently linked to the textile material. Tampering is thereby made difficult and is not possible without destroying the bond of textile material on the one hand and the non-contact circuit module on the other hand.

The fastening means can be configured as at least one mandrel attached to the non-contact circuit module and passing through the textile material and a button arranged on the opposite side of the textile material to the non-contact circuit module which receives one end of the mandrel.

This design of the fastening means allows a positive connection and is therefore particularly secure. With a reversibly detachable design, removal is only possible using a special tool to prevent unauthorised removal.

The fastening means can be formed as welding or bonding or coating or laminating or adhesion or crimping or adhesive film or by means of a patch connection produced under heat and pressure.

At the same time, the fastening means can be formed as a thermal or reaction adhesive.

A thermal adhesive is particularly preferred since known looms usually comprise a heatable roller. This can be appropriately used to join the non-contact circuit module to the textile material.

Furthermore, the fastening means can be formed from discrete connection points or very fine perforated adhesive film.

The restriction to discrete connection points or very fine film, i.e. thin and flexible perforated adhesive film avoids stiffening of the joined layers of the non-contact circuit module and the textile material.

The fastening means can also be formed from weaving yarns which are laid in the area of the non-contact circuit module above said non-contact circuit module and are woven outside said non-contact circuit module with the fabric of the textile material.

This makes it possible to achieve an integral fastening of the non-contact circuit module within the fabric of the textile material. The connection can be made within the industrial weaving production process usual for textiles.

The fastening means can be configured as a Velcro closure.

Rapid fastening and release of the non-contact circuit module is hereby possible.

The non-contact circuit module can be sealed with a coating.

This coating can effectively protect the non-contact circuit module against mechanical and chemical influences.

The invention is explained hereinafter with reference to exemplary embodiments shown in the drawings. In the figures:

FIG. 1 is a top view of the back of an unfolded narrow-band textile label with an E field emitter in asymmetric meander structures, where the continuous electrically conductive weft threads only run parallel to the warp threads in sections,

FIG. 2 is a top view of the back of an unfolded narrow-band textile label with an E field emitter in asymmetric meander structures, where the continuous electrically conductive weft threads run parallel and obliquely to the warp threads in sections,

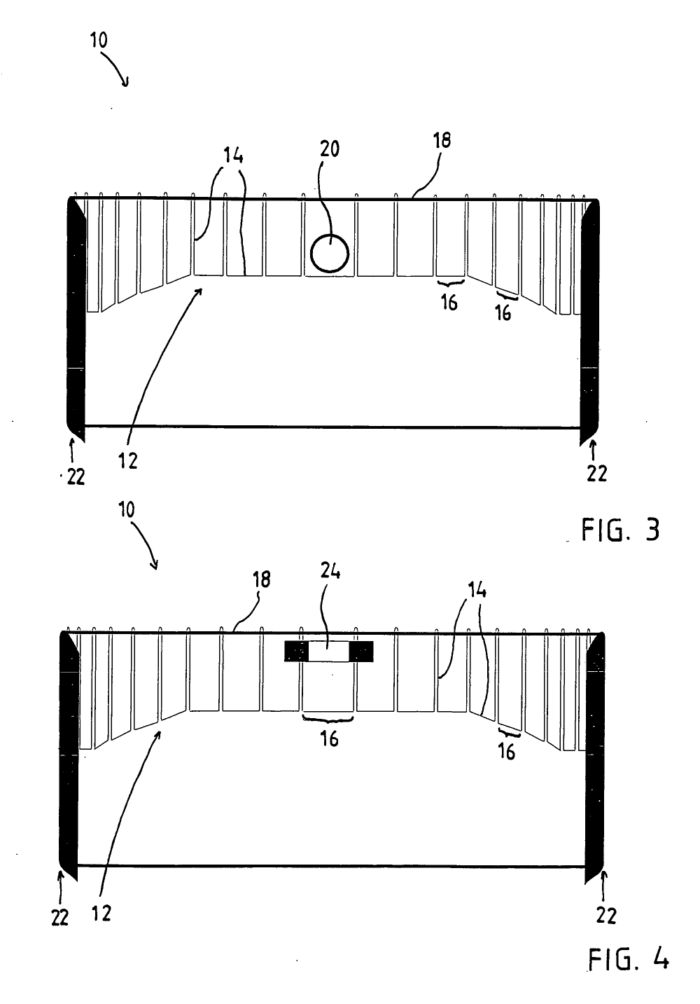

FIG. 3 is a top view of the back of a folded-end narrow-band textile label with an E field emitter in asymmetric meander structures and a non-contact circuit module, where the continuous electrically conductive weft threads have sections of different length which run parallel and obliquely to the warp threads,

FIG. 4 is a top view of the back of a folded-end narrow-band textile label with an E field emitter in asymmetric meander structures and a contacted circuit module, where the continuous electrically conductive weft threads have sections of different length which run parallel and obliquely to the warp threads,

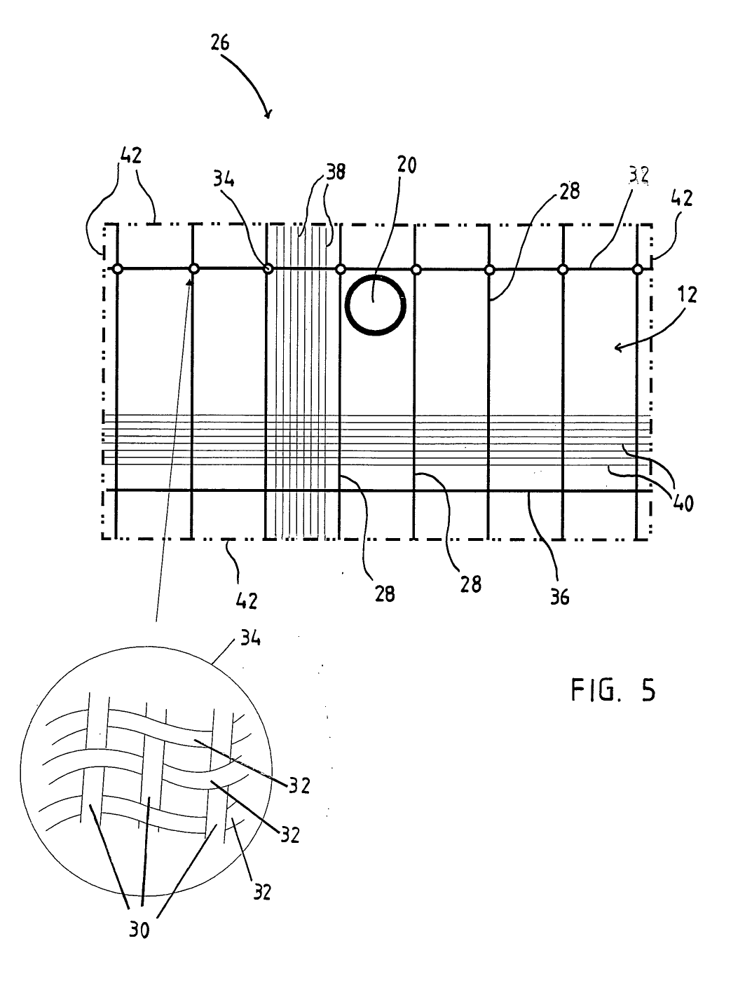

FIG. 5 is a top view of the back of a broad-band textile label with an E field emitter in the form of spaced-apart stubs which are connected in an electrically conducting manner by means of at least one warp thread, as well as a non-contact circuit module and

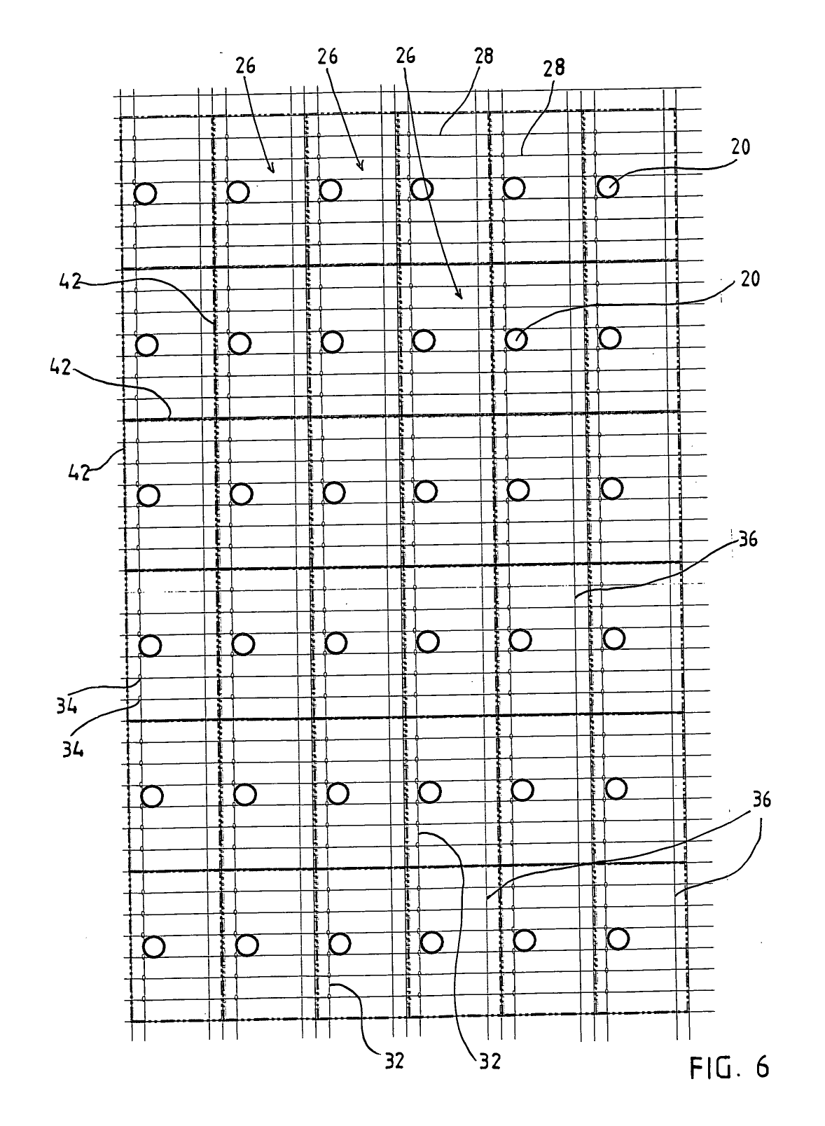

FIG. 6 is a top view of a plurality of the textile labels shown in FIG. 5 in the uncut state.

FIG. 1 is a top view of the back of a textile material in the form of unfolded narrow-band textile label 10 with an antenna 12. The textile label 10 was cut out from a row of interconnected textile labels. The cuts are shown schematically by the wavy lines shown on the left and right side of the textile label 10. The antenna 12 is configured as a mechanically shortened E field emitter. The antenna structures are formed by asymmetric meander structures, comprising a continuous electrically conductive weft thread 14 which runs in sections parallel to the warp threads not shown here and between the sections 16 is guided towards the effective edge 18 and immediately back therefrom transverse to the warp threads not shown. The effective edge 18 is also designated as a crochet edge.

Such an antenna structure can be produced simply at high production speed on a convention narrow-band loom together with the textile material.

FIG. 2 is a top view of the back of a textile material in the form of unfolded narrow-band textile label 10 with an antenna 12. The antenna 12 is configured as a mechanically shortened E field emitter. The antenna structures are formed by asymmetric meander structures, comprising a continuous electrically conductive weft thread 14 which runs in sections parallel and/or obliquely to the warp threads not shown here and between the sections 16 is guided towards the effective edge 18 and immediately back therefrom transverse to the warp threads not shown. The effective edge 18 is also designated as a crochet edge.

As has already been stated elsewhere, the continuous electrically conductive weft thread 14 is inserted at predefined positions somewhere in the textile material. The relative position of two adjacent positions predefines whether the section 16 formed by the continuous electrically conductive weft thread 14 runs parallel or obliquely to the warp threads not shown here.

As a result, various antenna structures can be implemented within the scope of the invention without the narrow-band loom needing to be expensively converted.

Since the continuous electrically conductive weft thread 14 runs obliquely to the warp threads not shown here in some sections 16, as shown, the antenna structure acquires a trimming function.

Another embodiment of an antenna structure is shown in FIG. 3. This shows a top view of the back of a textile material in the form of an end-folded narrow-band textile label 10 with an antenna 12 and a non-contact circuit module 20 comprising an electronic chip module and coupling element. The antenna 12 is configured as a mechanically shortened E field emitter. The antenna structures are formed by asymmetric meander structures, comprising a continuous electrically conductive weft thread 14 which runs in sections parallel and/or obliquely to the warp threads not shown here and between the sections 16 is guided towards the effective edge 18 and immediately back therefrom transverse to the warp threads not shown.

FIG. 3 clearly shows that the lengths of the sections 16 can be predefined. The further away or the later the insertion of the electrically conductive weft thread 14 following the previous insertion of the electrically conductive weft thread 14, the longer the sections 16.

As a result, numerous further antenna structures can be implemented within the scope of the invention. FIG. 3 shows, for example, an antenna structure which expands from above the centre of the textile label 10 to both sides, i.e. to left and right, over the entire length of the textile label 10 downwards in a trumpet shape. Such an antenna structure produces an optimum bandwidth. At the same time, the lengths of the sections 16 are reduced, the further they are from the centre of the textile label 10.

FIG. 3 shows that the textile label 10 is end-folded, i.e. folded to the left and right. Since the antenna structure runs over the total length of the textile label 10, the bandwidth of the antenna 12 is further increased by the antenna structure being doubled in the end fold 22.

The circuit module 20 is coupled into the antenna 12 in a non-contact manner. The arrangement of the circuit module 20 in the upper centre of the textile label between two insertions of the continuous electrically conductive weft thread 14 has proved particularly effective.

FIG. 4 shows a top view of the back of a folded-end narrow-band textile label 10 with an antenna 12 in asymmetric meander structures and a contacted circuit module 24.

The general structure of the textile label 10 shown with the antenna 12 corresponds to the textile label 10 shown in FIG. 3 so that to avoid repetitions, reference is made to the explanations relating to FIG. 3. The same reference numerals hereby designate the same parts.

Instead of a non-contact module, however a contacted circuit module 24 is provided in FIG. 4. This is arranged centrally between two insertions of the continuous electrically conductive weft thread 14 and is galvanically connected to these weft threads 14 running transversely to the warp threads not shown here. The galvanic connection can, for example, be a soldered connection.

FIG. 5 shows a top view of the back of a broad-band textile label 26 with an E field emitter 12 in the form of spaced-apart stubs 28 each formed by at least one, preferably by a plurality, of electrically conductive weft threads 30. The weft threads 30 forming the stubs 28 are woven with at least one, preferably with a plurality of electrically conductive warp threads 32 to produce conductive connections 34.

Such a connection 34 is shown in an enlarged view in FIG. 5. Here the electrically conductive weft threads 30 are interwoven with the electrically conductive warp threads 32 in a linen weave. This weaving of a plurality of electrically conductive threads 30, 32 has the result that the contact between the electrically conductive weft threads 30 and warp threads 32 is substantially improved.

A circuit module 20 comprising an electronic chip module and coupling element, which is coupled into the antenna 12 in a non-contact manner, is provided centrally between the stub 28 positioned next to the centre.

Also provided is at least one insulated electrically conductive weft thread 36 which crosses the electrically conductive weft threads 30 or the stubs 28. In practice this allows a mechanical shortening of the E field emitter 12.

FIG. 5 shows the textile label 26 produced by means of a broad loom which has been cut on all sides. As an example FIG. 5 also shows some electrically non-conductive textile weft threads 38 and warp threads 40. It can be clearly seen that the electrically non-conductive weft threads 38 hold the stubs 28 at a distance from one another. This has the result that a shortened dipole antenna 12 is formed in the textile label 26, not a patch.

FIG. 6 shows a top view of a plurality of the textile labels 26 shown in FIG. 5, produced by means of a broad loam in the uncut state.

During broad-band weaving, numerous textile labels 26 are usually produced in a production process and can be connected on all side to neighbouring textile labels 26. After broad-band weaving this textile labels 26 can be individually hot cut to seal the cut edges 42 with fixed fringes.

The arrangement of the electrically conductive weft and warp threads 30, 32 during broad band weaving is such that after cutting each textile label 26 has the antenna structure according to the invention, shown in FIG. 5.

FIG. 6 shows quite clearly that no different antenna structure is achieved if the warp threads were to be exchanged for weft threads and at the same time the weft threads for warp threads. Thus, the invention should be understood here and in the following such that the claimed one variant also comprises the second variant.

With regard to the description of the individual textile labels 26, to avoid repetitions reference is made to the description relating to FIG. 5, where the same reference numerals denote the same-parts.

### REFERENCE LIST

(is part of the description)
10 Narrow-band textile label
12 Antenna
14 Continuous electrically conductive weft thread
16 Section
18 Effective edge
20 Non-contact circuit module
22 End fold
24 Contacted circuit module
26 Broad band textile label
28 Stub
30 Electrically conductive weft thread
32 Electrically conductive warp thread
34 Conductive connection
36 Insulated electrically conductive warp thread
38 Electrically non-conductive textile weft thread
40 Electrically non-conductive textile warp thread
42 Cutting edge

1. A textile material comprising a circuit module (20, 24) and an antenna (12), wherein the antenna (12) is configured as an E field emitter for a working frequency in the UHF or microwave range and consists entirely of components of the textile material itself in the form of electrically conductive thread structures which are mechanically processed within the industrial weaving production process usual for textiles to form antenna structures, wherein during the narrow band weaving production process the antenna structures are formed by asymmetric meander structures comprising a continuous electrically conductive weft thread (14) which runs in sections parallel and/or obliquely to the warp threads and is guided forwards to the effective edge (18) and immediately backwards between the sections (16) transverse to the warp threads.

2. The textile material according to claim 1, wherein the electrically conductive weft thread (14) is insulated.

3. The textile material according to claim 1, wherein the sections (16) are configured to be the same or different length.

4. The textile material according to claim 1, wherein the textile material is a folded-end textile label (10), wherein the antenna structure runs over the entire length of the textile label (10) so that the antenna structure is doubled in the end fold (22).

5. The textile material according to claim 1, wherein at least one insulated, electrically conductive warp thread is provided which crosses the electrically conductive weft thread (14) or that at least one insulated or non-insulated electrically conductive warp thread is provided which is disposed adjacent to the antenna structure in a non-contact manner.

6. The textile material according to claim 1, wherein in the warp shed provided for the electrically conductive weft thread (14) guided forwards to the effective edge (18) and immediately backwards, at least one further textile weft thread (14) is guided forwards to the effective edge (18) and immediately backwards.

7. The textile material according to claim 1, wherein during the broad-band weaving production process, the antenna structures comprise a plurality of spaced-apart electrically conductive stubs (28), each formed by at least one, preferably by a plurality of electrically conductive weft threads (30), wherein the weft threads (30) forming the stubs (28) are interwoven with at least one, preferably with a plurality of a electrically conductive warp threads (32) to produce conductive connections (34).

8. The textile material according to claim 1, wherein during the broad-band weaving production process, the antenna structures comprise a plurality of spaced-apart electrically conductive stubs (28), each formed by at least one, preferably by a plurality of electrically conductive warp threads, wherein the warp threads forming the stubs are interwoven with at least one, preferably with a plurality of a electrically conductive weft threads to produce conductive connections.

9. The textile material according to claim 7, wherein the electrically conductive weft threads (30) are interwoven with the electrically conductive warp threads (32) in a linen weave.

10. The textile material according to claim 7, wherein additionally at least one electrically conductive insulated warp thread (36) is provided which cross over the stubs (28).

11. The textile material according to claim 8, wherein additionally at least one electrically conductive insulated weft thread is provided which cross over the stubs.

12. The textile material according to claim 1, wherein the electrically conductive thread or threads (14, 30, 32) are selected from the group comprising metal-coated plastic thread, a plastic thread wound with a metal wire or a metal strands, a plastic thread with an integrated metal wire or an integrated metal strand and a graphite thread.

13. The textile material according to claim 1, wherein the electrically conductive insulated thread or threads (14, 36) are selected from the group comprising a plastic thread with an integrated insulated metal wire, a plastic thread with an integrated insulated metal strand, an insulated metal wire and an insulated metal strand.

14. The textile material according to claim 1, wherein the circuit module (24) is coupled with the antenna structure with contact.

15. The textile material according to claim 1, wherein the circuit module (20) is coupled into the antenna in a non-contact manner.

16. The textile material according to claim 1, wherein the antenna is formed as a dipole.

17. The textile material according to claim 15, wherein an electronic chip module and a coupling element is arranged on the non-contact circuit module (20), wherein the coupling element is coupled inductively and/or capacitively into the antenna (12) of the textile material.

18. The textile material according to claim 17, wherein the non-contact circuit module (20) is fastened to the textile material by a reversibly detachable or irreversibly non-detachable fastening means.

19. The textile material according to claim 18, wherein the fastening means is configured as at least one mandrel attached to the non-contact circuit module (20) and passing through the textile material and a button arranged on the opposite side of the textile material to the non-contact circuit module (20) which receives one end of the mandrel.

20. The textile material according to claim 18, wherein the fastening means is formed as welding or bonding or coating or laminating or adhesion or crimping or adhesive film or by means of a patch connection produced under heat and pressure.

21. The textile material according to claim 18, wherein the fastening means is formed as thermo- or reaction adhesive.

22. The textile material according to claim 18, wherein the fastening means is formed from discrete connection points or very fine perforated adhesive film.

23. The textile material according to claim 18, wherein the fastening means is formed from weaving yarns which are laid in the area of the non-contact circuit module (20) above said non-contact circuit module (20) and are woven outside said non-contact circuit module (20) with the fabric of the textile material.

24. The textile material according to claim 17, wherein the non-contact circuit module (20) is sealed with a coating.

25. The textile material according to claim 24, wherein the coating at the same time forms an adhesive surface.
